(19) United States
(12) Patent Application Publication
(10) Pub. No.: US 2011/0248631 A1
(43) Pub. Date: Oct. 13, 2011

(54) LED LAMP SET

(76) Inventor: Sheng-Yi CHUANG, Hsinchu City (TW)

(21) Appl. No.: 12/773,347

(22) Filed: May 4, 2010

(30) Foreign Application Priority Data
Apr. 9, 2010 (TW) 099206214

(51) Int. Cl. H01K 1/62

(52) U.S. Cl. 315/32

(57) ABSTRACT

An LED lamp set includes a socket connecting to electric power, an ignition circuit board held in the socket to form electric connection therewith and a lamp assembly controlled by the ignition circuit board. The lamp assembly includes a stem and a plurality of LED substrates fastened to the stem. The stem has a plurality of troughs formed on the circumference and a plurality of spacers to separate the troughs. The stem further has an upper holding portion at the upper circumference to form a retaining space with the troughs and a sealed lower side connecting to a circuit board. The circuit board and the ignition circuit board are electrically connected. Each LED substrate has at least a portion wedged in the retaining space and is electrically connected to a plurality of LEDs. The LED substrate has an electric connection portion electrically connected to the circuit board.

### FIELD OF THE INVENTION

The present invention relates to an LED (light emitting diode) lamp set and particularly to an LED lamp set that has a stem to brace a plurality of LED substrates which hold a plurality of LEDs and form electric connection with the LEDs to emit light.

### BACKGROUND OF THE INVENTION

LED provides many advantages such as a longer lifespan, lower electric power consumption, greater luminosity and more eco-friendly in material used. With advance of LED manufacturing process and lower cost, it is now widely adopted on traffic lights or indication lights of electric appliances. Moreover, it is also being increasingly used on ornamental lights and illumination lamp sets. One of the greatest challenges for adopting the LEDs for indoor lighting is to conform to users' habit by displacing the conventional fluorescent lamps and incandescent lamps. The involved technique includes matching the LED lamp set with the electric connection specifications of existing lighting fixtures to make direct coupling possible, also offering fast replacement or repairs and maintenance of the LED lamp set, and providing LED illumination effect to meet most users' vision requirements on lighting. In order to promote the LEDs and enhance market competitiveness, many producers have developed various types of LED lamp sets. For instance, R.O.C. patent No. M334251 entitled “LED lamp set” discloses in its abstract: “An LED lamp set mainly includes a control circuit board and a plurality of LED cluster units. The control circuit board contains a control circuit and a plurality of pin holes connecting to the control circuit. The LED cluster units are located on a circuit board which holds a plurality of LEDs. The circuit board has pins at one end which are inserted into the pin holes of the control circuit board. The coupled control circuit board and LED cluster units are installed in varying types of lighting bulbs or an elongate lamp tube to form the LED lamp set. The control circuit ignites the LEDs to generate illumination effect. The number of the LED clusters units or LEDs can be increased or decreased according to illumination requirement. The LED lamp set thus formed can be made and assembled easily”. The LED lamp set previously discussed includes a control circuit board and a plurality of LED cluster units. The control circuit board has a control circuit and a plurality of pin holes connected to the control circuit. The LED cluster units are located on a circuit board which holds LEDs and pins at one end which are inserted into the pin holes of the control circuit board. As depicted in the claims and drawings in that case, the LED cluster units are formed by a small circuit board to hold a plurality of LEDs. The LED cluster units and the control circuit board are coupled through the pin holes and pins. However, the LED cluster units are mounted onto the control circuit board by bracing of the pins without much support strength. Any impact or shaking could result in breaking of the pins or separation of the LED cluster units from the control circuit.

To mount the LED circuit board firmer in a lamp set, a technique of providing a stem inside to support the circuit board has been developed as shown in R.O.C. patent No. M342460 entitled “Improved lamp socket”. Its abstract states that: “An improved lamp socket includes a socket, a bulb assembly and a sealing cap. The center of the top end of the socket is extended downwards to form a chamber and a plurality of insertion slots formed on the circumference and spaced from each other with a sealed bottom side. Each insertion slot has two sides formed a recess thereon to become a latch edge. An upright plate is held inside to divide the chamber. The upright plate in the chamber has two sides formed in an arched fashion and intersected to form a holding trench. The upright plate has a notch on the top end. The bulb assembly includes a plurality of holding boards and each of the holding boards is wedged with a plurality of LED bulbs. The holding boards are connected to a power cord and a control circuit which has electric control elements such as resistors and capacitors. By threading a conductive line into the chamber at the lower side of the control circuit, the control circuit forms electric connection with the metal cap. The sealing cap has one side extended to form a plurality of positioning pins. The number and positions of the pins mate the holding trench of the socket”. As depicted previously, it includes a socket, a bulb assembly and a sealing cap. The socket has the bottom end coupled with a metal cap to conduct electricity and form screw coupling, and the center of its top end extended downwards to form a chamber and a plurality of insertion slots formed on the circumference and spaced each other and parallel axially with a sealed bottom side. Each insertion slot has two sides formed a recess thereon to become a latch edge. An upright plate is held inside the chamber for partition. The upright plate in the chamber has two sides formed in an arched fashion and intersected to form a holding trench. The upright plate has a notch on the top end. The bulb assembly includes a plurality of holding boards, and each of the holding boards is wedged with a plurality of LED bulbs, then are connected to a control circuit which runs into the chamber of the socket through a conductive line to form connection with the metal cap. The insertion slots in the socket receive insertion of the bulb assembly, and the recesses on two sides of each insertion slot guide the card edge of the holding board so that the bulb assembly is mounted on the socket like through a track. The control circuit is held in the chamber. Due to the chamber has to hold the control circuit and the socket has to form a shell of a sufficient thickness to guide the latch edge of the holding board, the socket becomes bulky and difficult to shrink. Moreover, if there is a desire to increase the holding board to achieve uniform lighting, the socket has to be enlarged even more. As a result it is difficult to shrink the size of the lamp set and prone to be damaged when exposed in outside environments when in use (referring to its FIG. 4), or the lamp shade has to be specially made. All of these result in a higher cost.

### SUMMARY OF THE INVENTION

In view of the design problems of the conventional technique such as having difficulty to balance structural steadiness and illumination, and undesirable dimensional adaptability on the conventional lamp sets, the primary object of the present invention is to provide a structure that can firmly hold LEDs and offer sufficient space to house the LEDs to generate illumination in all directions, and also can be formed at a smaller size and adaptable to various types of illumination applications.

The present invention provides an LED lamp set which includes a socket connecting to electric power, an ignition circuit board held in the socket to form electric connection therewith and a lamp assembly controlled by the ignition circuit board. The lamp assembly includes a stem and a plurality of LED substrates fastened to the stem. The stem has a plurality of troughs on the circumference and a plurality of spacers to divide the troughs, and an upper holding portion located on an upper circumference to form a retaining space with the troughs, and a lower side connecting to a circuit board in a sealed manner. The circuit board is electrically connected to the ignition circuit board. The LED substrates are wedged in the troughs. Each LED substrate has at least a portion anchored on the retaining space. The LED substrate is electrically connected to a plurality of LEDs and has an electric connection portion to form electrical connection with the circuit board.

By means of the structure set forth above, the stem has the troughs formed thereon without the tracks at two sides as the conventional techniques do, hence the stem can be made thinner. Since the ignition circuit board is held in the socket rather than in the stem, the size can be further shrunk. The stem of the invention can hold multiple columns of LEDs to generate illumination in all directions. The lamp set of the invention also can be made at a smaller size and held in a glass bulb made in mass production to reduce production cost and improve adaptability.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the lamp set of the invention.

FIG. 2 is a schematic view of an LED substrate installed on an anchor trough.

FIG. 3 is a schematic view of the lamp assembly in an assembled condition.

FIG. 4 is a schematic view of the lamp assembly coupled with an ignition circuit board.

FIG. 5 is a sectional view of the LED lamp set.

FIG. 6 is a schematic view of an LED substrate ancillary anchor means.

FIG. 7 is a schematic view of another LED substrate ancillary anchor means.

### DETAILED DESCRIPTION OF THE PREFERRED EMBODIMENTS

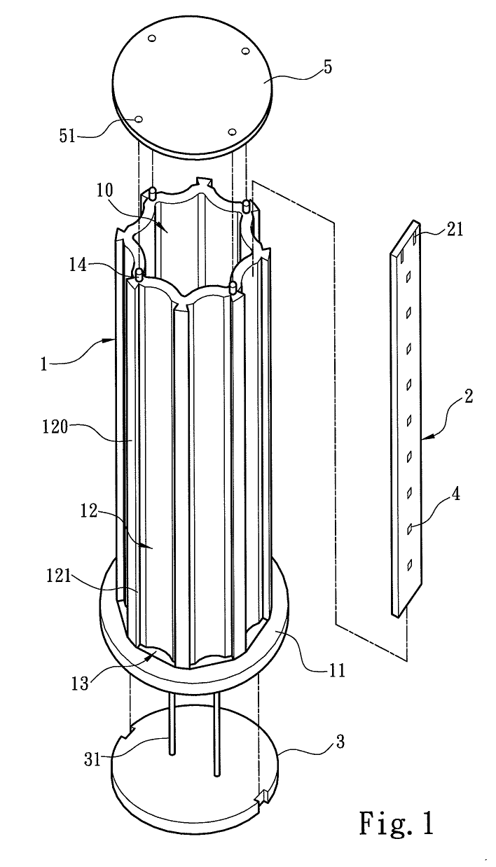

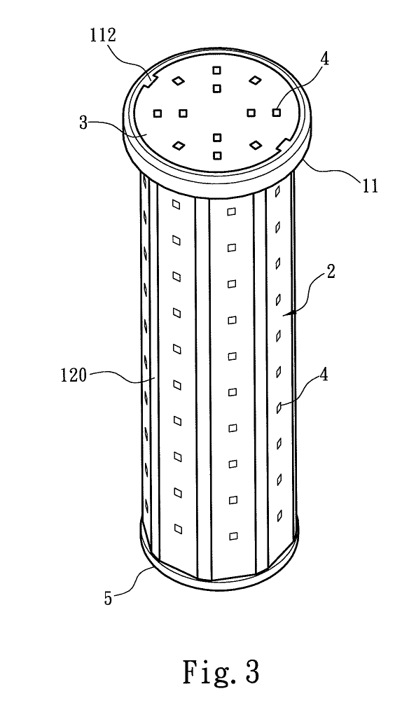

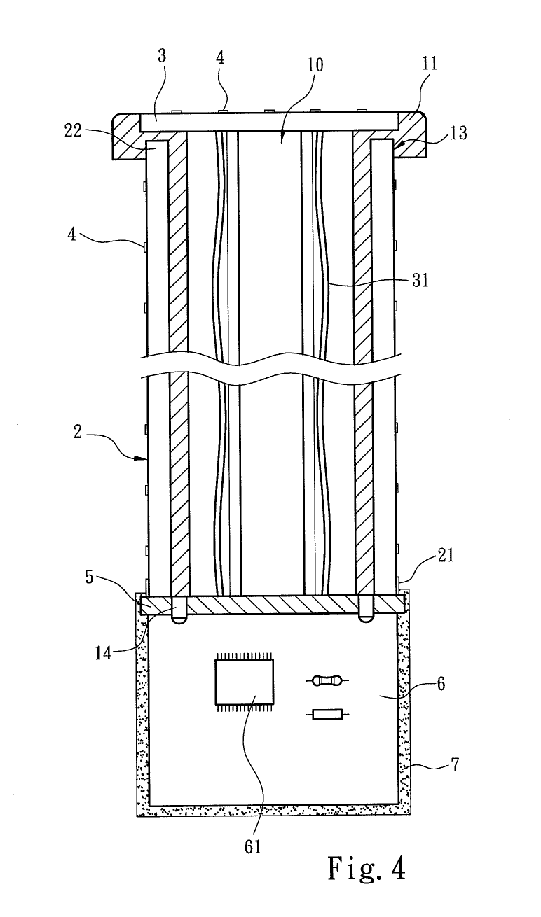

Referring to FIGS. 1 through 5, the present invention aims to provide an LED lamp set which includes a socket 8 connecting to electric power, an ignition circuit board 6 held in the socket 8 to form electric connection therewith and a lamp assembly driven by the ignition circuit board 6. The socket 8 includes at least a conductive metal portion to receive commercial electric power and has a chamber formed inside to hold the ignition circuit board 6. The ignition circuit board 6 contains a plurality of electronic elements 61 to electrically connect to the conductive metal portion of the socket 8 to get the commercial electric power and transform the commercial electric power into ignition electric power. The lamp assembly includes a stem 1 and a plurality of LED substrates 2 that are fastened to the stem 1 and also electrically connected to a plurality of LEDs 4. The stem 1 has a plurality of troughs 12 formed on the circumference which are separated by a plurality of spacers 120. The troughs 12 are formed in a number of at least six, preferably eight. The stem 1 further has an upper holding portion 11 on an upper circumference to form a retaining space 13 with the troughs 12. The LED substrates 2 are wedged in the troughs 12, and each LED substrate 2 has at least a portion anchored in the retaining space 13. Referring to FIG. 4, the LED substrate 2 has one end formed at a thickness and width fitly wedged in the retaining space 13 between the upper holding portion 11 and trough 12 such that the LED substrate 2 can be wedged smoothly in the trough 12. To facilitate positioning of the LED substrate 2, its back side may be coated with a binding adhesive (not shown in the drawings) to aid binding thereof on the trough 12. The lower side of the stem 1 is electrically connected to a circuit board 5 of the ignition circuit board 6 to form a sealing thereof. The stem 1 may have a plurality of positioning pins 14 and the circuit board 5 has a plurality of mating pin holes 51 run through by the positioning pins 14 to form coupling between the stem 1 and the circuit board 5. The LED substrate 2 has an electric connection portion to form electric connection with the circuit board 5 as shown in FIG. 1. The electric connection portion may be a plurality of conductive contacts 21 to form electric connection with the circuit board 5 by soldering (but not the limitation). Hence the LEDs 4 on the LED substrate 2 form electric connection with the ignition circuit board 6 through the circuit board 5 and are driven by the ignition electric power to generate light. It is to be noted that the trough 12 is formed at a width limited by the spacers 120. Each spacer 120 has an inner side edge 121 formed in a flat and straight tangent plane on the left and right sides to confine the position of the LED substrate 2 without forming a trench-type track so that the stem 1 can be formed without taking into account of the thickness between the troughs 12, as a result the troughs 12 can be spaced from each other at a smaller distance so that the stem 1 with a smaller diameter allows a greater number of troughs 12.

In addition, to prevent the lamp assembly from moving sideway during transportation or use, the stem 1 has to provide firmer support strength. To meet this end, one approach is to couple the circuit board 5 on the ignition circuit board 6 with the ignition circuit board 6 latched on the socket 8 to provide the support strength needed. Another approach is encase the circuit board 5 with a bracing holder 7 with the positioning pins 14 running through the circuit board 5 (referring to FIG. 4). The bracing holder 7 which is covered by an isolation and insulation resin so as to encase the circuit board 5 and positioning pins 14 formed at a size wider than the stem 1 and firmer. Moreover, the bracing holder 7 may also fully fill the surrounding of the circuit board 5 to form a compact package to firmly hold the stem 1. Furthermore, the bracing holder 7 may also encase the ignition circuit board 6 at the same time to provide desired insulation and isolation effect to meet various safety regulations and standards. The isolation and insulation resin forming the bracing holder 7 may be thermal conductive to channel heat from the bracing holder 7.

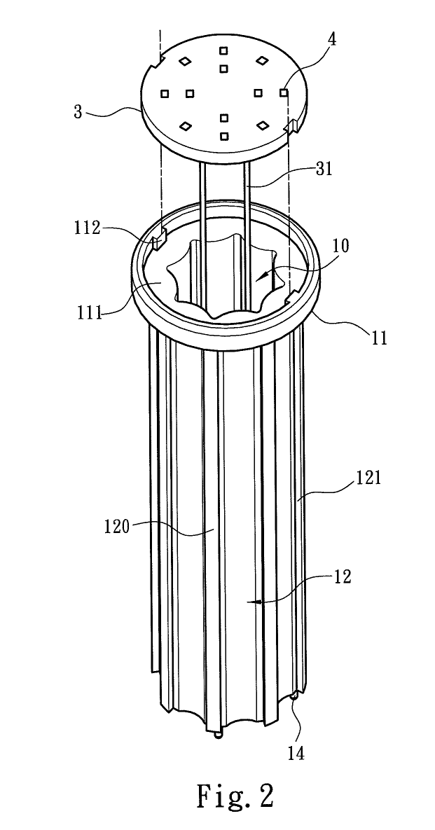

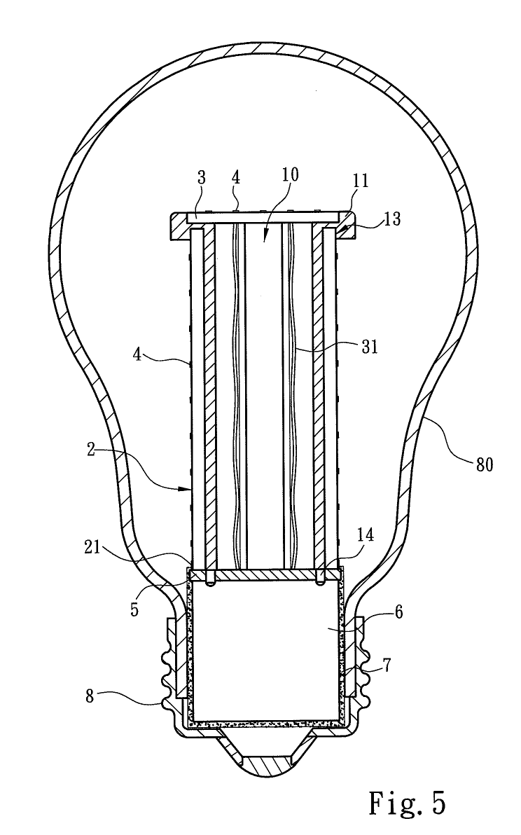

To facilitate light projection at the front side, the upper holding portion 11 has an anchor trough 111 with one LED substrate 3 wedged therein. The LED substrate 3 may be formed in a shape mating the anchor trough 111 as shown in FIG. 2. The anchor trough 111 has at least one anchor lug 112 to hold the LED substrate 3 in the anchor trough 111. In addition, the LED substrate 3 may also be bound to the anchor trough 111 through an adhesive (not shown in the drawings). Moreover, the stem 1 may have a wiring space 10 formed therein and threaded through by a plurality of conductive lines 31 to establish electrical connection with the circuit board 5 and also get the ignition electric power from the ignition circuit board 6. Thus the LEDs 4 on the LED substrate 3 can get the ignition electric power at the same time to produce illumination at the front side and in all directions. Referring to FIG. 5, the socket 8 can be coupled with a lamp shade 80 to encase the lamp assembly and the ignition circuit board 6. As the stem 1 can be formed at a smaller size and also help to generate illumination in all directions, and the lamp shade 80 can be a glass lighting bulb fabricated in mass production now available, production cost can thus be reduced.

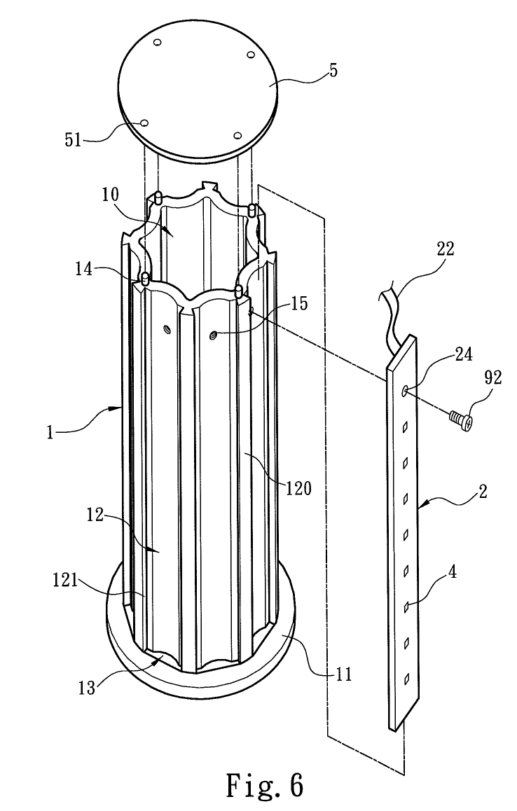

Refer to FIG. 6 for another embodiment of the invention. As previously discussed, the LED substrate 2 is wedged in the retaining space 13 of the stem 1 and held firmly through an ancillary means. In FIG. 6, the trough 12 of the stem 1 has at least one fastening hole 15, while the LED substrate 2 also has at least another mating fastening hole 24. After the LED substrate 2 is wedged in the trough 12, the fastening holes 15 and 24 can be fastened together through a fastening element 92 to aid positioning of the LED substrate 2 in the trough 12. The fastening element 92 may be a screw. As shown in FIG. 6, the electric connection portion of the LED substrate 2 can be a plurality of conductive lines 22 electrically connected to the circuit board 5.

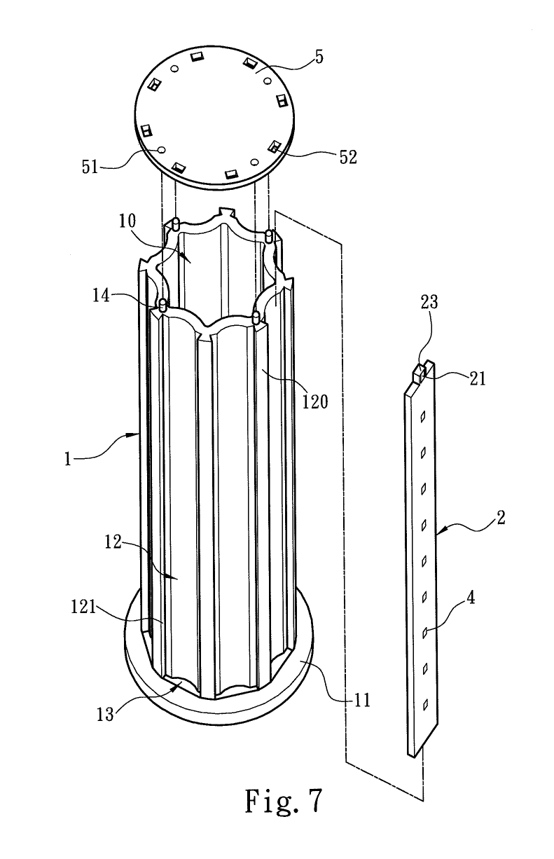

Refer to FIG. 7 for another embodiment of the ancillary positioning means of the LED substrate 2. The LED substrate 2 has at least one ancillary anchor lug 23 while the circuit board 5 has a plurality of apertures 52 mating the anchor lug 23. After the LED substrate 2 is wedged in the trough 12, the anchor lug 23 can be wedged in one of the apertures 52 to aid positioning of the LED substrate 2 in the trough 12. It is to be noted that the electric connection portion shown in FIG. 1 is implemented through the conductive contacts 21. The positions of the conductive contacts 21 are not limited to the ones shown in FIG. 1, but also can be formed as shown in FIG. 7. In FIG. 7, the LED substrate 2 has the ancillary anchor lug 23, and the conductive contacts 21 are formed on the surface of the ancillary anchor lug 23. As shown in FIG. 7, with the conductive contacts 21 formed on the inner and outer surfaces of the ancillary anchor lug 23 (with only the conductive contacts 21 formed on the outer surface are shown, while the ones on the inner surface are not shown), electric connection can be established between the conductive contacts 21 and the circuit board 5 through connection of the ancillary anchor lug 23 and the circuit board 5 (through a conductive copper foil held in the aperture 52; the copper foil is not shown in the drawing due to size and angle constraints).

As a conclusion, by means of the technique set forth above, with the troughs 12 formed on the stem 1 in the invention, there is no need to form tracks at two sides of the LED substrate 2 as the conventional techniques do. As a result, the thickness of the stem 1 can be reduced. Moreover, the ignition circuit board 6 is held in the socket 8 rather than in the interior of the stem 1, total size can be further shrunk. Since the stem 1 of the invention can hold multiple columns of LEDs 4 to generate illumination in all directions, and can be encased in a glass bulb made in mass production, production cost is lower and adaptability improves.

While the invention have been described by means of specific embodiments, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. An LED lamp set comprising a socket connecting to and receiving electric power, an ignition circuit board held in the socket and electrically connected thereto and a lamp assembly driven by the ignition circuit board, wherein the lamp assembly includes:
a stem which includes a plurality of troughs and a plurality of spacers separating the troughs formed on the outer circumference thereof, an upper holding portion located on an upper circumference to form a retaining space with the troughs and a circuit board at a lower side thereof electrically connected to the ignition circuit board to seal the lower side; and
a plurality of LED substrates wedging into the troughs, each of the LED substrates being electrically connected to a plurality of LEDs and includes an electric connection portion electrically connected to the circuit board and at least a portion held in the retaining space.

2. The LED lamp set of claim 1, wherein the circuit board includes a plurality of pin holes, the stem includes a plurality of positioning pins running through the pin holes to fasten the stem to the circuit board.

3. The LED lamp set of claim 2, wherein the circuit board and the positioning pins running through the circuit board are encased by a bracing holder.

4. The LED lamp set of claim 3, wherein the bracing holder encases the circuit board and the positioning pins through an isolation and insulation resin.

5. The LED lamp set of claim 4, wherein the isolation and insulation resin is a heat conductive resin.

6. The LED lamp set of claim 3, wherein the bracing holder also encases the ignition circuit board.

7. The LED lamp set of claim 1, wherein the electric connection portion of the LED substrate is a plurality of conductive contacts.

8. The LED lamp set of claim 1, wherein the electric connection portion of the LED substrate is a plurality of conductive lines.

9. The LED lamp set of claim 1, wherein the LED substrates include respectively a back side coated with adhesive to bind the troughs to aid the LED substrates to be positioned in the troughs.

10. The LED lamp set of claim 1, wherein the LED substrates and the troughs include respectively at least one fastening hole fastened by a fastening element to aid the LED substrates to be positioned in the troughs.

11. The LED lamp set of claim 1, wherein the circuit board includes a plurality of apertures, each LED substrate includes an ancillary anchor lug wedged in one aperture to aid the LED substrate to be positioned in the trough.

12. The LED lamp set of claim 1, wherein the upper holding portion includes an anchor trough thereon, one LED substrate being electrically connected to LEDs being anchored on the anchor trough and electrically connected to the circuit board through at least one conductive line.

13. The LED lamp set of claim 12, wherein the stem includes a wiring space threaded through by the conductive line to form electric connection between the LED substrates and the circuit board.

14. The LED lamp set of claim 1, wherein the stem includes at least six troughs.

15. The LED lamp set of claim 14, wherein the stem includes eight troughs.

16. The LED lamp set of claim 14, wherein the troughs are equally spaced on the outer circumference of the stem.

17. The LED lamp set of claim 1, wherein the socket is coupled with a lamp shade to encase the lamp assembly and the ignition circuit board.
